(19) United States
(12) Patent Application Publication
(10) Pub. No.: US 2006/0075263 A1
(43) Pub. Date: Apr. 6, 2006

(54) System and method for security and file retrieval from remote computer

(76) Inventor: Jesse Taylor, Cumming, GA (US)

Correspondence Address: ARNALL GOLDEN GREGORY LLP, 1201 West Peachtree Street, Atlanta, GA, 30309, US

(21) Appl. No.: 10/800,488

(22) Filed: Mar. 15, 2004

(51) Int. Cl. G06F 12/14

(52) U.S. Cl. 713/194

(57) ABSTRACT

A system and method that secures select data in a mobile computing device and retrieves the select data at a remote server. An application is installed on the mobile computing device which sends a periodic signal to the remote server and receives an acknowledgement signal from the remote server indicating if the mobile device is stolen. If the mobile computing device is separated from its rightful owner, the owner may request the remote server to secure and retrieve select data from the mobile computing device. Upon receipt of the mobile device signal, the remote server sends a retrieval request to the mobile computing device. After receiving the retrieval request, the mobile computing device secures the select data, sends the secured data to the remote server, and then deletes the select data from the mobile computing device.

### BACKGROUND OF THE INVENTION

1. Field of the Invention

The present invention generally relates to computer software, and more specifically, relates to a system and method for securing and retrieving data from a remote computer.

2. Description of the Related Art

Advances in technology have made computers smaller and cheaper. Now it is not uncommon to see people carrying laptop or notebook computers from one place to another, so they can remain productive even outside their office or home. They can take their work to anywhere they go and they can be instantly connected to other computers if the mobile computer is equipped with a wireless modem or a wireless network interface card.

However, like any other personal properties, these mobile computers are prone to be lost or stolen. Upon the mobile computer being stolen, besides losing a valuable property and facing the difficult problem of recovery of a lost property, a user is confronted with the problem of having his private files accessible by a third party. These files may have certain sensitive personal information. These files may also be the only copy of an on-going project that the user desperately needs. The user therefore desires, upon compromise of the mobile computer, to prevent other people from reviewing his personal information and, most importantly, the user desires to have these files back. In some cases, these files are more important to the user than the lost computer.

Unfortunately, most security systems now available to mobile computers only assist a user to locate the lost computer and cannot help him to prevent others to access private files on the lost computer or recover these files in a timely fashion.

### SUMMARY OF THE INVENTION

The present invention is an apparatus and method for securing and retrieving select information from a mobile device. In one embodiment, the invention is a method for securing data in a mobile computing device through transmitting a periodic signal from the mobile computing device to a remote server, and receiving a retrieval request at the mobile computing device from the remote server, wherein the retrieval request includes a data identification for identifying original resident data at the mobile computing device. In response to the retrieval request, the original resident data identified by the data identification is secured preferably by creating a secure file of the original resident data, and after the secure file is created, the original resident data from which the secure file was made is deleted from the mobile computing device.

In another embodiment, the invention is a method for recovering data from a mobile computing device by transmitting a periodic signal from the mobile computing device to a remote server, and receiving a retrieval request at the mobile computing device from the remote server, wherein the retrieval request includes a data identification for identifying original resident data at the mobile computing device. In response to the retrieval request, the original resident data identified by the data identification is selected and sent from the original resident data to the remote server, and after sending the original resident data, the mobile computer deletes the original resident data.

In yet another embodiment, the invention is a method for both securing data in a mobile computing device and recovering the data through a server through the following steps of receiving a periodic signal from the mobile computing device, the periodic signal having an identification information for identifying the mobile computing device, comparing the identification information with a subscriber data in the server, and if the subscriber data indicates retrieval of data from the mobile computing device, then transmitting a retrieval request from the server to the mobile computing device, wherein the retrieval request includes a data identification for identifying original resident data on the mobile computing device, and receiving a secured file containing the original resident data secured from the mobile computing device.

In yet another embodiment, the invention is a system for securing data in a mobile computing device. The system comprises a mobile computing device in communication with a remote server, wherein the mobile computing device being capable of transmitting a periodic signal from the mobile computing device to the remote server, and upon receiving an retrieval request from the remote server, with the retrieval request includes a data identification for identifying original resident data on the mobile computing device. In response to the retrieval request, the computing device further being capable of securing the original resident data identified by the data identification by creating a secure file of the original resident data, and after creating the secure file, deleting the original resident data from the computing device.

In yet another embodiment, the invention is a system for surreptitiously transmitting data from a computing device. The system comprises a mobile computing device in communication with a remote server, wherein the mobile computing device being capable of transmitting a periodic signal from the mobile computing device to the remote server, receiving a retrieval request from the remote server, wherein the retrieval request includes a data identification for identifying original resident data. In response to the retrieval request, the mobile computing device further being capable of selecting the original resident data identified by the data identification, surreptitiously sending the original resident data from the mobile computing device to the remote server, and after sending the original resident data, deleting the original resident data from the computing device.

In yet another embodiment, the invention is a system for securing data in a mobile computing device and recovering the data through a remote server. The system comprises a remote server in communication with a mobile computing device, wherein the remote server being capable of receiving a periodic signal from the computing device, the periodic signal having an identification information for identifying the mobile computing device, and comparing the identification information with a subscriber data in the server. If the subscriber data indicates retrieval of data from the mobile computing device, the remote server further being capable of transmitting a retrieval request to the mobile computing device, wherein the retrieval request includes a data identification for identifying original resident data on the mobile computing device, and receiving a secure file from the mobile computing device, the secure file containing the original resident data.

In yet another embodiment, the invention is a computer-readable medium on which is stored a computer program for securing data in a mobile computing device and recovering the data through a remote server, wherein the computer program comprising instructions which, when executed by a mobile computing device, perform the steps of transmitting a periodic signal from the mobile computing device to a remote server, receiving an retrieval request from the remote server, wherein the retrieval request includes a data identification for identifying original resident data on the mobile computing device. In response to the retrieval request, the computer program further performs the steps of securing an original resident data identified by the data identification by creating a secure file of the original resident data, and after creating the secure file, deleting the original resident data from the mobile computing device.

In yet another embodiment, the invention is a computer-readable medium on which is stored a computer program for recovering data from a mobile computing device through a remote server, wherein the computer program comprising instructions which, when executed by a mobile computing device, perform the steps of transmitting a periodic signal from the mobile computing device to the remote server, receiving an retrieval request from the remote server, wherein the retrieval request includes a data identification for identifying original resident data on the mobile computing device. In response to the retrieval request, the computer program further performs the steps of selecting the original resident data identified by the data identification, sending the original resident data to the remote server, and after sending the original resident data, deleting the original resident data from the mobile computing device.

In yet another embodiment, the invention is a computer-readable medium on which is stored a computer program for securing data in a mobile computing device and recovering the data through a remote server, wherein the computer program comprising instructions which, when executed by a server, perform the steps of receiving a periodic signal from the computing device, the periodic signal having an identification information for identifying the mobile computing device, and comparing the identification information with a subscriber data in the server. If the subscriber data indicates retrieval of data from the mobile computing device, the computer programs further performs the steps of transmitting a retrieval request to the mobile computing device, wherein the retrieval request includes a data identification for identifying original resident data on the mobile computing device, and receiving a secure file from the mobile computing device, the secure file containing the original resident data.

Other advantages and features of the present invention will become apparent after review of the hereinafter set forth Brief Description of the Drawings, Detailed Description of the Invention, and the Claims.

### BRIEF DESCRIPTION OF THE DRAWINGS

FIG. 1 is an architecture of a system according to the invention.

FIG. 2 is a flow chart for a monitoring process on a mobile computing device.

FIG. 3 is a flow chart for a user request process.

FIG. 4 is a flow chart for a monitoring process on a monitoring server.

FIG. 5 is a flow chart for a recovery process.

### DETAILED DESCRIPTION OF THE INVENTION

In this description, the terms “laptops,” “notebooks,” and “mobile computers” are used interchangeably, and “fetch” and “download” are used interchangeably, the term “application” or “program” as used herein is intended to encompass executable and non-executable software files, raw data, aggregated data, patches, and other code segments. Further, like numerals refer to like elements throughout the several views, and the articles “a” and “the” includes plural references, unless otherwise specified in the description.

As technology progresses, laptop or notebook computers come more affordable and more convenient. Many people have to replace traditional desktop computers for easy to carry laptops. A laptop allows a user to carry his work, his personal data with him to anywhere he goes. If a laptop or mobile computer is equipped with a communication device, the laptop may enable a user to access a remote server. The most common communication devices include modem and network interface card. The modem and the network interface card can be either wired or wireless. The present invention uses these communication devices to help users to secure and retrieve select files from a lost mobile computer. The present invention can be implemented on any mobile computer to include laptop, PDA's, cell phones, advanced pagers, or other mobile hardware.

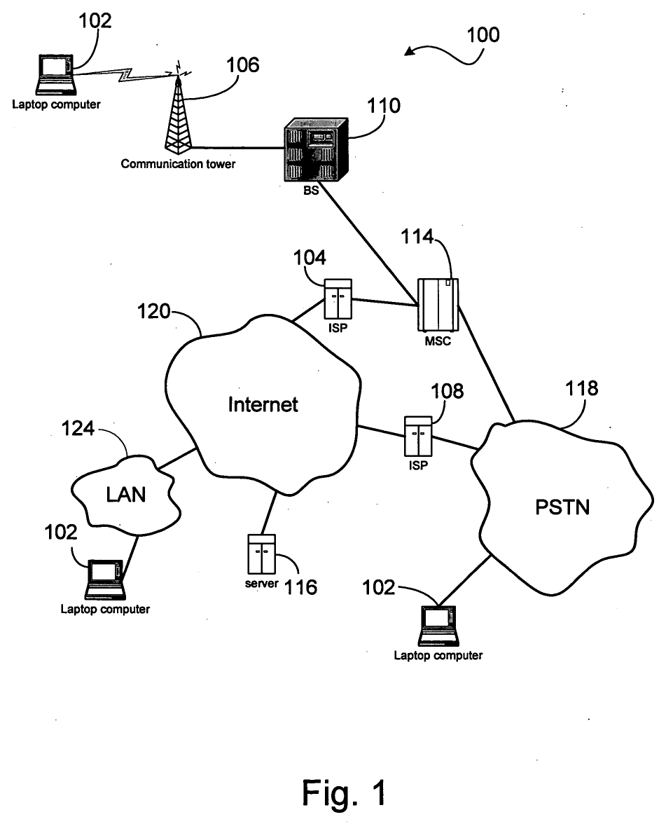

FIG. 1 depicts a communication network 100 where a mobile computer according to the present invention may be used. The communication network 100 includes one or more communication towers 106, each tower 106 connected to a base station (BS) 110 and serving users with a mobile device 102. The mobile device 102 can be cellular telephones with a personal telephone list, personal digital assistants (PDAs) with a personal agenda, laptop computers, or other hand-held, stationary, or portable communication devices that use a wireless and cellular telecommunication network. The commands and data input by each user are transmitted as digital data to a communication tower 106. The communication between a user using a mobile device 102 and the communication tower 106 can be based on different technologies, such code division multiplexed access (CDMA), time division multiplexed access (TDMA), frequency division multiplexed access (FDMA), the global system for mobile communications (GSM), or other protocols that may be used in a wireless communications network or a data communications network. The data from each user is sent from the communication tower 106 to the base station (BS) 110, and forwarded to a mobile switching center (MSC) 114, which may be connected to a public switched telephone network (PSTN) 118 and the Internet 120. The MSC 114 may be connected to a server 104 that supports different applications available to subscribers using the mobile device 102. Optionally, the server 104 may be part of the MSC 114.

A user may use the mobile device 102 to access the Internet 120 via the MSC 114 to reach the server 104, then through the server 104 to surf the Internet 120. A user may also reach the Internet 120 by connecting his mobile device 102 to a local area network (LAN) 124. Finally, a user may reach the Internet 120 by dialing into the PSTN 118 and being connected to his Internet service provider (ISP) 108 and then reach the Internet 120.

To protect a user from unfortunate incidents of losing his laptop and exposing his private data to third parties, the user may use the system provided by the present invention. The user may sign up a data securing and recovery service with a monitoring service provider who operates a monitoring server 116 in communication with the Internet 120. A specially devised application is installed on his laptop. After the installation, this application is hidden inside the laptop and not easily identified by other users. The application posses certain intelligence that allows it to communicate periodically with the server 116 and receives instructions from this server 116. When instructed by the server 116, the laptop will secure certain personal data and optionally send this data back to the server 116 before deleting these personal data from the laptop and making it inaccessible to a person who is using the laptop at that time. All these operations are executed in a manner that is transparent to and without knowledge from the person.

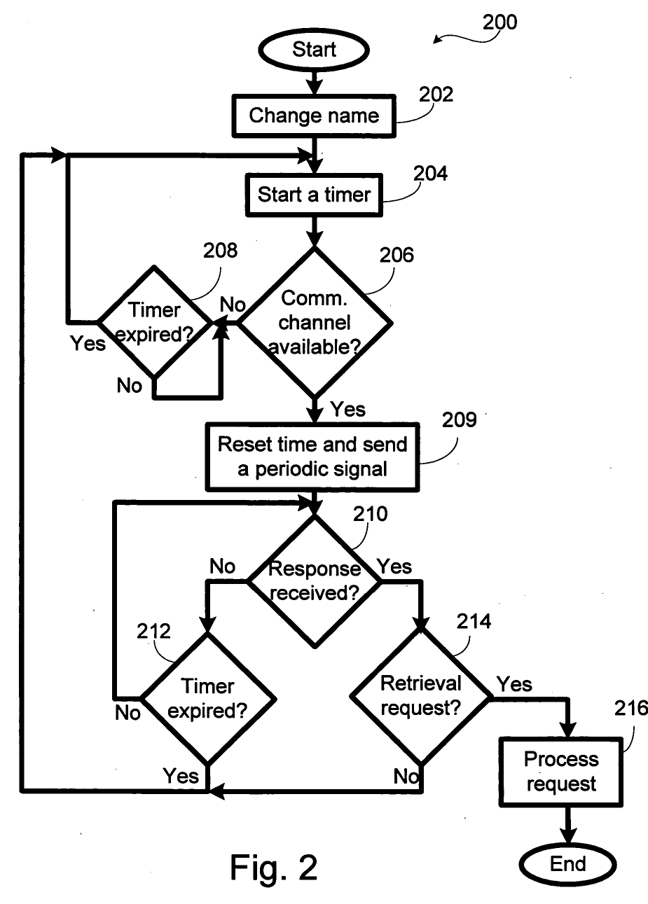

FIG. 2 is a flow chart for a monitoring process 200 running on a mobile device 102. Though the application can be stored anywhere in the mobile device's file system, it is preferably stored in a boot sector and not visible to a user; the application may also change its name every time it runs, so it is difficult for the user detect and remove it. The application automatically starts with every boot procedure and the first it does is to change its name, step 202. Besides changing its name, it may also move its location from one location to a different location. The application starts a timer, step 204, and checks whether a communication channel is available for it to use, step 206. The communication channel may be a channel established by a communication device such as a modem or a network interface card. If the communication channel is not available, because either the modem is not connected to any telephone line or the network interface card is not connected to any network, the application checks whether the timer has expired, step 206. After the timer expires, the application resets the timer, step 204, and repeats the cycle of checking for a communication channel.

If a communication channel is available, for example, a telephone line is connected to the modem, the application resets the timer, dials a predefined telephone number to connect to the monitoring server 116, and sends a periodic signal to the monitoring server 116, step 209. A periodic signal may be a simple data message with the mobile device's identification information or a ping signal. After sending the periodic signal, the application checks for a response, step 210. If a response is not received before the timer expires, step 212, the application repeats the process of checking for the communication channel and sending the periodic message. If a response is received from the monitoring server 116, the application checks whether it is a special retrieval request, step 214. If the response is an ordinary acknowledgement message, the application repeats the cycle. If the response is a retrieval request, the application then processes this request, step 216. This cycle of checking for a communication channel, sending a periodic message, and checking for a response is repeated without interference from the user, and the cycle is performed whether the user is the legitimate owner of the mobile device or an unauthorized third party.

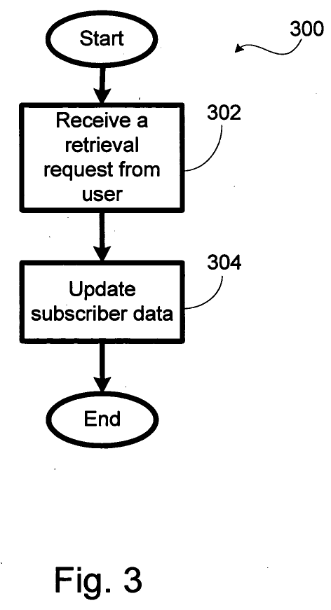

However, if the mobile device 102 is lost or stolen, the owner may report the incident to the monitoring service provider. FIG. 3 is a flow chart for a user request process 300. The monitoring service provider receives a notification from the owner stating that the mobile device is lost and he wishes to secure and retrieve his personal data, step 302. The monitoring service provider updates this information in a subscriber data, step 304, which is used to handle the periodic messages. The owner may also specify a list of data to be secured on the mobile device. Alternatively, the owner may specify the data to be recovered when he installed the application on the mobile device.

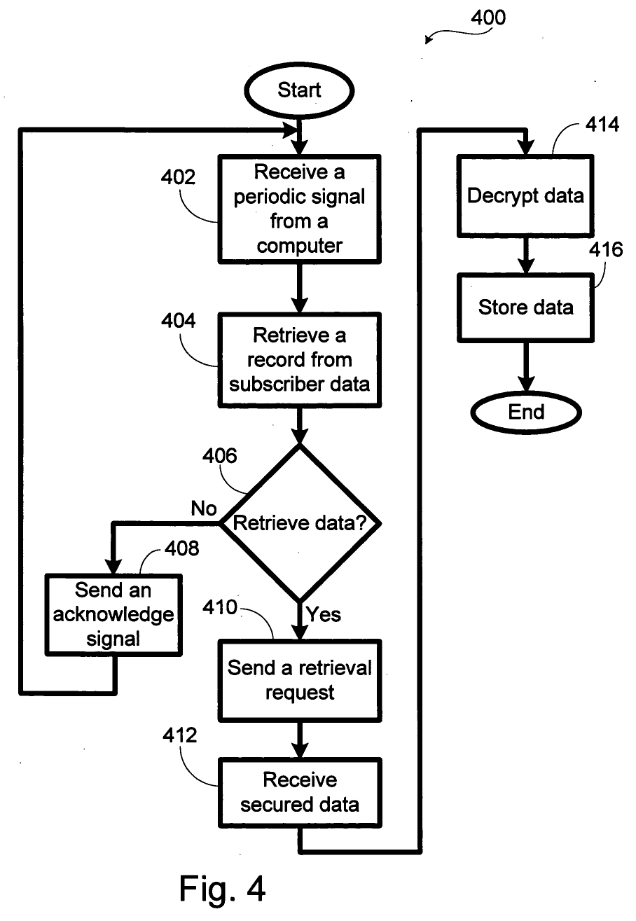

FIG. 4 illustrates a monitoring process 400 on a monitoring server 116. The monitoring server 116, after receiving a periodic message, step 402, checks for the mobile device identification information embedded in the periodic message and retrieves a record associated with the identification information from the subscriber data, step 404. If the record indicates that the subscriber wants to secure and retrieve the data, step 406, the monitoring server 116 sends a retrieval request to the mobile device 102. If the record does not indicate that the subscriber wants to retrieve the data, the monitoring server 116 sends a simple acknowledgement signal back to the mobile device 102, step 408. After the monitoring server 116 sends the retrieval request, the monitoring server 116 may receive a secure data from the mobile device 102, step 412. The data is preferably secured through encryption because it may have sensitive personal data. The data may also be compressed as to save the bandwidth during the transmission and make the transfer faster. After receiving the secure data, the monitoring server 116 proceeds to decrypt the data, step 414, and store the data, step 416, for retrieval by the subscriber.

Optionally, the monitoring server 116 may obtain the mobile device's location information. If the communication device used by the mobile device 102 is a telephone line, the monitoring server 116 can get the origination telephone number through the automatic number identification (ANI) feature provided by the telephone service provider. If the mobile device 102 sends the periodic message through the Internet, the monitoring server 116 may obtain the Internet Protocol (IP) address from where the periodic message and secure data are received.

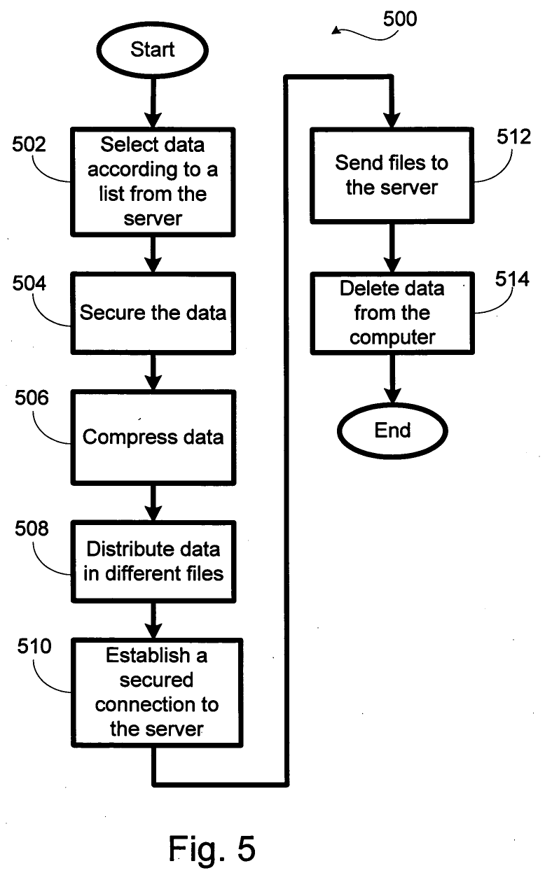

FIG. 5 is a recovery process and an expansion of step 216 in FIG. 2. The application on the mobile device 102 receives a retrieval request from the monitoring server 116, and checks the information in the retrieval request. The request retrieval may include a list of data to be secured. The application selects data according to the list from the request retrieval or a list predefined by the owner of the mobile device 102, step 502, and secures the data, step 504. The application may secure the data by encryption. The encryption may be done by any of available mechanisms well known to people skilled in the art.

After securing the data, the application may compress the secure data, step 506. The compression may make the size of the secure data smaller and thus easier to transfer to the monitoring server 116. If the secure data remain sizeable, the application may break the secure data into different files of smaller size, step 508. The application proceeds to establish a secured connection to the monitoring server 116, step 510. The establishment of a secured connection is well known to those skilled in the art. After the secured connection is established, the application sends the secure data, or broken down files, to the monitoring server 116, step 512, and deletes the original personal data from the mobile device 102, step 514. The mobile device 102 may delete the original personal data after encrypting them without transmitting the encrypted data to the monitoring server 116 if the owner lent the mobile device 102 to a friend and does not want the personal data be available to this friend. The owner may use the application or a different program to recover the encrypted data after the friend returns the mobile device to him.

When transferring the secure data to the monitoring server 116, the application may establish a connection from the mobile device 102 to the monitoring server 116 according to the File Transfer Protocol (FTP) or Hyper Text Transfer Protocol (HTTP). In order to make the transfer of secure data in a transparent manner and by-pass any security detection such as a fire wall protection, the application may opt to send the secure data as data packets that are commonly used by a web browser for transferring information to and from the Internet, or through a select point of the mobile device.

The following is a description of one use scenario according to one embodiment of the invention. The description is for illustration purposes and not intended to limit the scope of the invention in any way. A user buys a multi-function wireless telephone that includes an expense recording application and a personal database. Besides using the wireless telephone for communication purposes, the user uses the wireless telephone to record his business expenses and contact information of his business associates. The user signs up for the monitoring service, as described herein, with a monitoring service provider and a monitoring application is loaded into a wireless telephone. The user may specify which file is important to him and he may want to retrieve in the event that his wireless telephone is lost.

After signing up for the monitoring service, every time the user powers up the wireless telephone, the monitoring application sends a periodic message to a monitoring server and checks for the response from the monitoring server. The period message may be sent as a data message through a data channel to the wireless service provider which in turn forwards it to the monitoring service provider. The monitoring application repeats this process during the entire time that the wireless telephone is powered up.

If the wireless telephone is lost, the user notifies the monitoring service provider and requests that the personal contact list and the expense record file be retrieved from the wireless telephone. After receiving the request from the user, the monitoring service provider inputs the user's request in its database. The next time the monitoring server receives a periodic message from this wireless device the monitoring server, instead of sending an acknowledgement message, sends a retrieval request to the wireless device.

The wireless telephone receives the retrieval request, identifies the files to be secured and retrieved, and encrypts the files. After encrypting the files, the wireless telephone deletes the original files and transmits the encrypted files to the monitoring server.

In view of the method being executable on either a computing device or a server, the present invention includes a program resident in a computer readable medium, where the program directs either the computing device or the server having a computer platform to perform the steps of the method. The computer readable medium can be the memory of the device, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In the context of FIGS. 2-5, the method may be implemented, for example, by operating portion(s) of the wireless network to execute a sequence of machine-readable instructions, such as wireless communications device or the server. The source code of an exemplary embodiment of the invention is disclosed on the CD ROM appendix. The instructions can reside in various types of signal-bearing or data storage primary, secondary, or tertiary media. The media may comprise, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. A method for securing data in a mobile computing device, comprising the steps of:
transmitting a periodic signal from the mobile computing device to a remote server;
receiving a retrieval request at the mobile computing device from the remote server, wherein the retrieval request includes a data identification for identifying original resident data at the mobile computing device;
in response to the retrieval request,
securing an original resident data identified by the data identification by creating a secure file of the original resident data, and
after creating the secure file, deleting the original resident data from the mobile computing device.

2. The method of claim 1, further comprising the step of compressing the secure file.

3. The method of claim 1, wherein the step of securing an original resident data further comprising the steps of:
receiving an encrypting key from the remote server; and
encrypting the original resident data using the encryption key.

4. A method for recovering data from a mobile computing device, comprising the steps of:
transmitting a periodic signal from the mobile computing device to a remote server;
receiving a retrieval request at the mobile computing device from the remote server, wherein the retrieval request includes a data identification for identifying original
resident data at the mobile computing device;
in response to the retrieval request,
selecting the original resident data identified by the data identification,
sending the original resident data to the remote server, and
after sending the original resident data, deleting the original resident data from the mobile computing device.

5. The method of claim 4, further comprising the step of dividing the original resident data into a plurality of segments of a predetermined size.

6. The method of claim 4, further comprising the step of compressing the original resident data on the mobile computing device.

7. The method of claim 4, further comprising the step of establishing a secured connection between the mobile computing device and the remote server.

8. The method of claim 4, further comprising the step of establishing a FTP connection between the mobile computing device and the remote server.

9. The method of claim 4, further comprising the step of establishing a HTTP connection between the mobile computing device and the remote server.

10. A method for securing data in a mobile computing device and recovering the data through a server, comprising the steps of:
receiving a periodic signal from the mobile computing device, the periodic signal having an identification information for identifying the mobile computing device;
comparing the identification information with a subscriber data in the server; and
if the subscriber data indicates retrieval of data from the mobile computing device,
transmitting a retrieval request from the server to the mobile computing device, wherein the retrieval request includes a data identification for identifying original resident data on the mobile computing device, and
receiving a secured file containing the original resident data secured from the mobile computing device.

11. The method of claim 10, further comprising the step of, if the subscriber data does not indicate retrieval of data from the mobile computing device, transmitting an acknowledgement signal to the mobile computing device.

12. The method of claim 10, further comprising the step of decrypting the secured data received from the mobile computing device.

13. The method of claim 10, wherein the step of receiving the secured file further comprising the steps of:
receiving a plurality of segments of secured data from the mobile computing device; and
assembling the plurality of segments of secured data into the secured file.

14. The method of claim 10, further comprising the step of establishing a secured connection between the mobile computing device and the server.

15. The method of claim 10, further comprising the step of establishing a FTP connection between the mobile computing device and the server.

16. The method of claim 10, further comprising the step of establishing a HTTP connection between the mobile computing device and the server.

17. The method of claim 10, further comprising the step of, if the subscriber data indicates retrieval of location data for the mobile computing device, receiving a location data from a service provider.

18. The method of claim 17, wherein the service provider is a telephone service provider and the location data is an origination telephone number through which the mobile computing device communicates with the server.

19. The method of claim 17, wherein the service provider is an Internet service provider and the location data is a network address through which the mobile computing device communicates with the server.

20. The method of claim 10, further comprising the steps of:
receiving a retrieval indicator from a user; and
storing the retrieval indicator in the subscriber data.

21. A mobile computing device that selectively communicates with a remote server, the mobile computing device transmitting a periodic signal from the mobile computing device to the remote server,
receiving an retrieval request from the remote server, wherein the retrieval request includes a data identification for identifying original resident data on the mobile computing device, and
in response to the retrieval request,
securing original resident data identified by the data identification by creating a secure file of the original resident data, and
after creating the secure file, deleting the original resident data from the computing device.

22. The computing device of claim 21, further being capable of compressing the secure file.

23. The computing device of claim 21, further being capable of:
receiving an encrypting key from the remote server; and
encrypting the original resident data using the encryption key.

24. A mobile computing device selectively in communication with a remote server, the mobile computing device transmitting a periodic signal from the mobile computing device to the remote server,
receiving an retrieval request from the remote server, wherein the retrieval request includes a data identification for identifying original resident data; and
in response to the retrieval request,
selecting the original resident data identified by the data identification,
sending the original resident data from the mobile computing device to the remote server, and
after sending the original resident data, deleting the original resident data from the computing device.

25. The computing device of claim 24, further being capable of dividing the original resident data into a plurality of segments of a predetermined size.

26. The computing device of claim 24, further being capable of sending an acknowledgement signal to the remote server.

27. The computing device of claim 24, further being capable of establishing a secured connection between the mobile computing device and the remote server.

28. The computing device of claim 24, further being capable of establishing a FTP connection between the mobile computing device and the remote server.

29. The computing device of claim 24, further being capable of establishing a HTTP connection between the mobile computing device and the remote server.

30. A remote server in selective communication with one or more mobile computing devices, the remote server selectively recovering data from one or more mobile computing devices through
receiving a periodic signal from the computing device, the periodic signal having an identification information for identifying the mobile computing device; and
comparing the identification information with subscriber data in the server;
if the subscriber data indicates retrieval of data from the mobile computing device,
transmitting a retrieval request to the mobile computing device, wherein the retrieval request includes a data identification for identifying original resident data on the mobile computing device, and
receiving a secure file from the mobile computing device, the secure file containing the original resident data.

31. The remote server of claim 30, further being capable of, if the subscriber data does not indicate retrieval of data from the computing device, sending an acknowledgement signal to the mobile computing device.

32. The remote server of claim 30, further being capable of decrypting the secure file.

33. The remote server of claim 30, wherein the step of receiving the secure file further comprising the steps of:
receiving a plurality of segments of secure data; and
assembling the plurality of segments of secure data into the secure file.

34. The remote server of claim 30, further being capable of establishing a secured connection between the mobile computing device and the remote server.

35. The remote server of claim 30, further being capable of establishing a FTP connection between the mobile computing device and the remote server.

36. The remote server of claim 30, further being capable of establishing a HTTP connection between the mobile computing device and the remote server.

37. The remote server of claim 30, further being capable of, if the subscriber data indicates retrieval of location data for the mobile computing device, receiving a location data from a service provider.

38. The remote server of claim 37, wherein the service provider is a telephone service provider and the location data is an origination telephone number through which the mobile computing device communicates with the remote server.

39. The remote server of claim 37, wherein the service provider is an Internet service provider and the location data is a network address through which the mobile computing device communicates with the remote server.

40. The remote server of claim 30, further being capable of:
receiving a retrieval indicator from a user; and
storing the retrieval indicator in the subscriber data.

41. A computer-readable medium on which is stored a computer program for securing data in a mobile computing device from commanding by a remote server, the computer program comprising instructions which, when executed by the mobile computing device, cause the device to perform the steps of:
transmitting a periodic signal from the mobile computing device to a remote server;
receiving a retrieval request from the remote server, the retrieval request includes a data identification for identifying original resident data on the mobile computing device;
in response to the retrieval request,
securing an original resident data identified by the data identification by creating a secure file of the original resident data, and
after creating the secure file, deleting the original resident data from the mobile computing device.

42. The computer program of claim 41, further performing the step of compressing the secure file.

43. The computing program of claim 42, further performing the steps of:
receiving an encrypting key from the remote server; and
encrypting the secure file using the encryption key.

44. A computer-readable medium on which is stored a computer program for securing data in a mobile computing device and recovering the data through transmission to a remote server, the computer program comprising instructions which, when executed by a mobile computing device, perform the steps of:
transmitting a periodic signal from the mobile computing device to the remote server;
receiving a retrieval request from the remote server, wherein the retrieval request includes a data identification for identifying original resident data on the mobile computing device;
in response to the retrieval request,
selecting the original resident data identified by the data identification,
sending the original resident data to the remote server, and
after sending the original resident data, deleting the original resident data from the mobile computing device.

45. The computer program of claim 44, further performing the step of dividing the original resident data into a plurality of segments of a predetermined size.

46. The computer program of claim 44, further performing the step of receiving an acknowledgement signal from the remote server.

47. The computer program of claim 44, further performing the step of establishing a secured connection between the mobile computing device and the remote server.

48. The computer program of claim 44, further performing the step of establishing a FTP connection between the mobile computing device and the remote server.

49. The computer program of claim 44, further performing the step of establishing a HTTP connection between the mobile computing device and the remote server.

50. A computer-readable medium on which is stored a computer program for securing data in a mobile computing device and recovering the data through a remote server, the computer program comprising instructions which, when executed by a remote server, perform the steps of:
receiving a periodic signal from a computing device, the periodic signal having an identification information for identifying the mobile computing device; and
comparing the identification information with a subscriber data in the server;
if the subscriber data indicates retrieval of data from the mobile computing device,
transmitting a retrieval request to the mobile computing device, wherein the retrieval request includes a data identification for identifying original resident data on the mobile computing device, and
receiving a secure file from the mobile computing device, the secure file containing the original resident data.

51. The computer program of claim 50, further performing the step of, if the subscriber data does not indicate retrieval of data from the mobile computing device, transmitting an acknowledgement signal to the mobile computing device.

52. The computer program of claim 50, further performing the step of decrypting the secure file.

53. The method of claim 50, wherein the step of receiving the secure file further comprising the steps of:
receiving a plurality of segments of secure data; and
assembling the plurality of segments of secure data into the secure file.

54. The computer program of claim 50, further performing the step of establishing a secured connection between the mobile computing device and the remote server.

55. The computer program of claim 50, further performing the step of establishing a FTP connection between the mobile computing device and the remote server.

56. The computer program of claim 50, further performing the step of establishing a HTTP connection between the mobile computing device and the remote server.

57. The computer program of claim 50, further performing the step of, if the subscriber data indicates retrieval of location data for the mobile computing device, receiving a location data from a service provider.

58. The method of claim 57, wherein the service provider is a telephone service provider and the location data is an origination telephone number through which the mobile computing device communicates with the remote server.

59. The method of claim 57, wherein the service provider is an Internet service provider and the location data is a network address through which the mobile computing device communicates with the remote server.

60. The computer program of claim 50, further performing the step of:
receiving a retrieval indicator from a user; and
storing the retrieval indicator in the subscriber data.
